(19) United States
(12) Patent Application Publication
(10) Pub. No.: US 2013/0055111 A1
(43) Pub. Date: Feb. 28, 2013

(54) SOCIAL NETWORKING SYSTEM, APPARATUS, AND METHOD

(71) Applicants: Gabe Peyton, Arlington, VA (US); Josh Peyton, Arlington, VA (US)

(72) Inventors: Gabe Peyton, Arlington, VA (US); Josh Peyton, Arlington, VA (US)

(21) Appl. No.: 13/597,768

(22) Filed: Aug. 29, 2012

Related U.S. Application Data
(60) Provisional application No. 61/528,993, filed on Aug. 30, 2011.
(60) Provisional application No. 61/539,707, filed on Sep. 27, 2011.

(51) Int. Cl. G06F 3/01

(52) U.S. Cl. 715/753

(57) ABSTRACT

A social networking system, apparatus and method are provided. For example, a user of a computing system may quickly and easily select a subset of a group of individuals with whom he or she wishes to communicate. The user may also choose to “eavesdrop” on conversations between other individuals in the group and potentially participate in the discussion.

### CROSS REFERENCE TO RELATED APPLICATIONS

This application claims priority of U.S. Provisional Patent Application Ser. Nos. 61/528,993, filed Aug. 30, 2011, and 61/539,707, filed Sep. 27, 2011. The subject matter of these earlier-filed applications is hereby incorporated by reference in its entirety.

### FIELD

The present invention generally relates to social networking, and more specifically, to a social networking system, apparatus, and method facilitating interaction between users for various relationships and/or interests, such as sporting events.

### BACKGROUND

Social networking services exist that bring individuals together who share friendships, intimate relationships, or family relationships, or share common activities and/or interests. Users may be represented by a profile and be linked to other users (as with Facebook , for example). Most such services are web-based and are accessed via a web browser, although applications on mobile computing devices such as the iPhone® and Android® are becoming increasingly common.

However, while such websites and applications may provide forum functionality where users may post messages to one another or message one another in groups, a more interactive and natural way to communicate between users may be beneficial.

### SUMMARY

Certain embodiments of the present invention may provide solutions to the problems and needs in the art that have not yet been fully solved by conventional social networking applications. For example, certain embodiments of the present invention provide a social messaging application that allows a user of a computing system to quickly and easily select a subset of a group of individuals with whom he or she wishes to communicate. In some embodiments, the user may also choose to “eavesdrop” on conversations between other individuals in the group and potentially participate in the discussion. “Social messaging” includes, but is not limited to, text messages (e.g., via Short Message Service (“SMS”)), posts, private messages, and public messages.

In one embodiment of the present invention, a computer program is embodied on a non-transitory computer-readable medium. The program is configured to cause at least one processor to display a first page or screen with a plurality of designations of members of a group to a user. The program is also configured to cause the at least one processor to receive and store a plurality of group member selections made by the user. The program is further configured to cause the at least one processor to receive and store a social message from the user, and to send the social message to the plurality of selected group members.

In another embodiment of the present invention, a computer program is embodied on a non-transitory computer-readable medium. The program is configured to cause at least one processor to receive and store a plurality of group member selections from a user or an automated process. The program is also configured to cause the at least one processor to display one or more conversations between two or more of the plurality of selected group members to the user.

In yet another embodiment of the present invention, a computer-implemented method includes receiving and storing, by a computing system, a plurality of group member selections from a user or an automated process. The computer-implemented method also includes displaying, by the computing system, one or more conversations between two or more of the plurality of selected group members to the user.

### BRIEF DESCRIPTION OF THE DRAWINGS

In order that the advantages of certain embodiments of the invention will be readily understood, a more particular description of the invention briefly described above will be rendered by reference to specific embodiments that are illustrated in the appended drawings. While it should be understood that these drawings depict only typical embodiments of the invention and are not therefore to be considered to be limiting of its scope, the invention will be described and explained with additional specificity and detail through the use of the accompanying drawings, in which:

FIG. 1 illustrates a computing system for facilitating social networking, according to an embodiment of the present invention.

FIG. 2 illustrates an architectural diagram of a social networking system, according to an embodiment of the present invention.

FIG. 3A illustrates a screen of a social networking application showing a plurality of group members, according to an embodiment of the present invention.

FIG. 3B illustrates the screen of the social networking application after multiple users have been selected, according to an embodiment of the present invention.

FIG. 4A illustrates a screen of a social networking application showing a plurality of group members, according to an embodiment of the present invention.

FIG. 4B illustrates the screen of the social networking application after a plurality of group members have been selected, according to an embodiment of the present invention.

FIG. 5 illustrates a screen of a social networking application where communications between selected group members are shown, according to an embodiment of the present invention.

FIG. 6 illustrates a screen of a social networking application where communications between selected group members are shown, according to an embodiment of the present invention.

FIG. 7 illustrates a flowchart of a method for receiving and storing selections of group members, according to an embodiment of the present invention.

FIG. 8 illustrates a flowchart of a method for monitoring, viewing, and joining in on group member conversations, according to an embodiment of the present invention.

FIG. 9 illustrates a flowchart of a method for facilitating quick and easy selection of group members, according to an embodiment of the present invention.

FIG. 10 illustrates a flowchart of a method for “eavesdropping” on a conversation between a pair or group of group members, according to an embodiment of the present invention.

### DETAILED DESCRIPTION OF THE EMBODIMENTS

It will be readily understood that the components of various embodiments of the present invention, as generally described and illustrated in the figures herein, may be arranged and designed in a wide variety of different configurations. Thus, the following more detailed description of the embodiments of the present invention, as represented in the attached figures, is not intended to limit the scope of the invention as claimed, but is merely representative of selected embodiments of the invention.

The features, structures, or characteristics of the invention described throughout this specification may be combined in any suitable manner in one or more embodiments. For example, reference throughout this specification to “certain embodiments,” “some embodiments,” or similar language means that a particular feature, structure, or characteristic described in connection with the embodiment is included in at least one embodiment of the present invention. Thus, appearances of the phrases “in certain embodiments,” “in some embodiment,” “in other embodiments,” or similar language throughout this specification do not necessarily all refer to the same group of embodiments and the described features, structures, or characteristics may be combined in any suitable manner in one or more embodiments.

Some embodiments of the present invention pertain to a gaming social networking system where users can register and login to follow the teams they like, view scores, news, and feeds from other users for the games they are interested in. Users can add friends and create groups, or can be a part of an existing group. Users can also participate in polls and can chat with friends or other group members. However, the methods, systems, and apparatuses discussed herein may be applied to applications other than gaming, and the scope of the applications to which the technology can be applied is not limited in any way to games and/or sports.

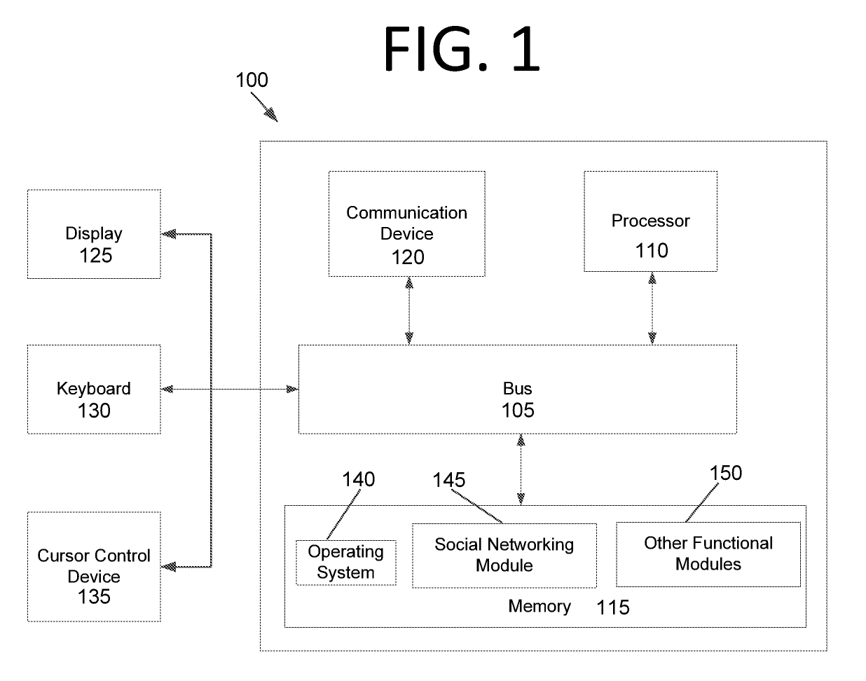

FIG. 1 illustrates a computing system 100 for facilitating social networking, according to an embodiment of the present invention. System 100 includes a bus 105 or other communication mechanism for communicating information, and a processor 110 coupled to bus 105 for processing information. Processor 110 may be any type of general or specific purpose processor, including a central processing unit (“CPU”) or application specific integrated circuit (“ASIC”). Processor 110 may also be a multicore processor and/or a collection of multiple processors. System 100 further includes a memory 115 for storing information and instructions to be executed by processor 110. Memory 115 can be comprised of any combination of random access memory (“RAM”), read only memory (“ROM”), flash memory, cache, static storage such as a magnetic or optical disk, or any other types of non-transitory computer-readable media or combinations thereof. Additionally, system 100 includes a communication device 120, such as a wireless network interface card or a transceiver, to provide access to a network.

Non-transitory computer-readable media may be any available media that can be accessed by processor 110 and may include both volatile and non-volatile media, removable and non-removable media, and communication media. Communication media may include computer- readable instructions, data structures, program modules or other data in a modulated data signal such as a carrier wave or other transport mechanism and includes any information delivery media.

Processor 110 is further coupled via bus 105 to a display 125, such as a Liquid Crystal Display (“LCD”), for displaying information to a user. A keyboard 130 and a cursor control device 135, such as a computer mouse, are further coupled to bus 105 to enable a user to interface with system 100.

In one embodiment, memory 115 stores software modules that provide functionality when executed by processor 110. The modules include an operating system 140 for system 100. The modules further include a social networking module 145 that is configured to facilitate interaction between a plurality of users. System 100 may include one or more additional functional modules 150 that include additional functionality.

One skilled in the art will appreciate that a “system” could be embodied as a personal computer, a server, a console, a personal digital assistant (“PDA”), a cell phone, a tablet computing device, or any other suitable computing device, or combination of devices. Presenting the above-described functions as being performed by a “system” is not intended to limit the scope of the present invention in any way, but is intended to provide one example of many embodiments of the present invention. Indeed, methods, systems and apparatuses disclosed herein may be implemented in localized and distributed forms consistent with computing technology.

It should be noted that some of the system features described in this specification have been presented as modules, in order to more particularly emphasize their implementation independence. For example, a module may be implemented as a hardware circuit comprising custom very large scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise one or more physical or logical blocks of computer instructions that may, for instance, be organized as an object, procedure, or function. Nevertheless, the executables of an identified module need not be physically located together, but may comprise disparate instructions stored in different locations which, when joined logically together, comprise the module and achieve the stated purpose for the module. Further, modules may be stored on a computer-readable medium, which may be, for instance, a hard disk drive, flash device, RAM, tape, or any other such medium used to store data.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

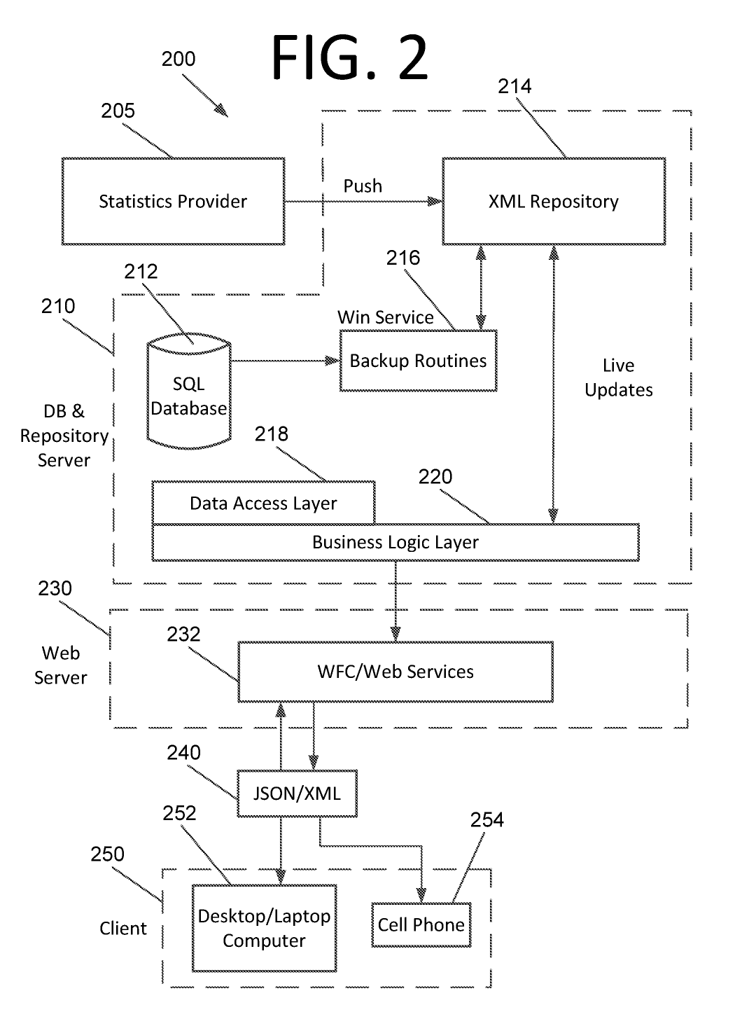

FIG. 2 illustrates an architectural diagram 200 of a social networking system, according to an embodiment of the present invention. The architecture depicted in this embodiment is a three-tier architecture including a database (“DB”) and repository server 210, a web server 230, and a client 250. In some embodiments, full support to Representational State Transfer (“REST”) based Windows Communication Foundation (“WCF”) services from a live feed as well as interaction with a Structured Query Language (“SQL”) database 212 are included in the architecture. However, embodiments of the present invention are not limited to Windowe-based systems, and any suitable operating system and/or architecture may be used depending on design choice. WCF services may be a core part of the architecture, and functionality may be exposed to client 250 by WCF services in certain embodiments.

Statistics provider 205 may provide data via a push operation to Extensible Markup Language (“XML”) repository 214 of database and repository server 210. XML repository 214 is capable of providing live updates to business logic layer 220 and also communicates with backup routines 216, which operate as a Win service. SQL database 212 also communicates with backup routines 216.

The core application may consist of a business logic layer 220, a data access layer 218, and a presentation layer (not shown) that exists on desktop/laptop computer 252 and cell phone 254. These three layers may interact with SQL database 212 and any other common resource. In this embodiment, business logic layer 220 contains all of the business logic, and hence logical activities are handled by this layer. Also in this embodiment, data access layer 218 contains all database related activities, so business logic is not present in this layer. Data access layer 218 may use, for example, a SQL Helper class library for interactive functionality with SQL database 212. The presentation layer deals with the look-and-feel of the application. Various screens and controls on pages or Win forms may be defined in this layer. The presentation layer may be client-specific, and hence different for devices such as the iPhone®, Android® phones, personal computers, etc.

In web server 230, WFC/web services 232 deal with services and may be the main communication point for the application. Various services are exposed via the WCF platform. The output of these services may be totally REST-based for easy consumption thereof by client devices. Security for external communications of the application may be handled by any suitable mechanism, such as Secure Socket Layer (“SSL”). Communications between WFC/web services 232 and the client devices (desktop/laptop computer 252 and cell phone 254) may take the form of JavaScript Object Notation (“JSON”) or XML, as shown in JSON/XML 240.

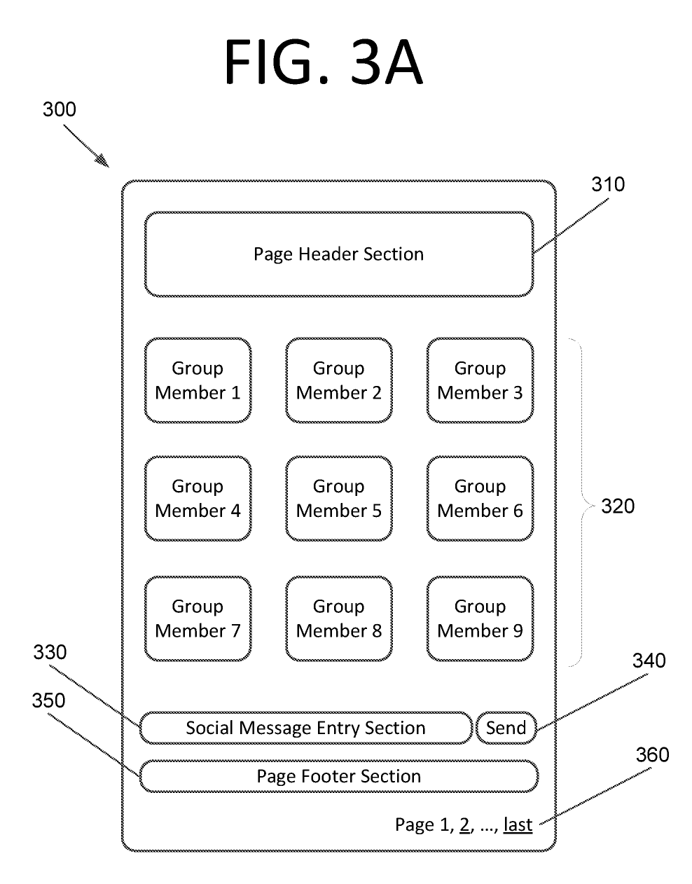

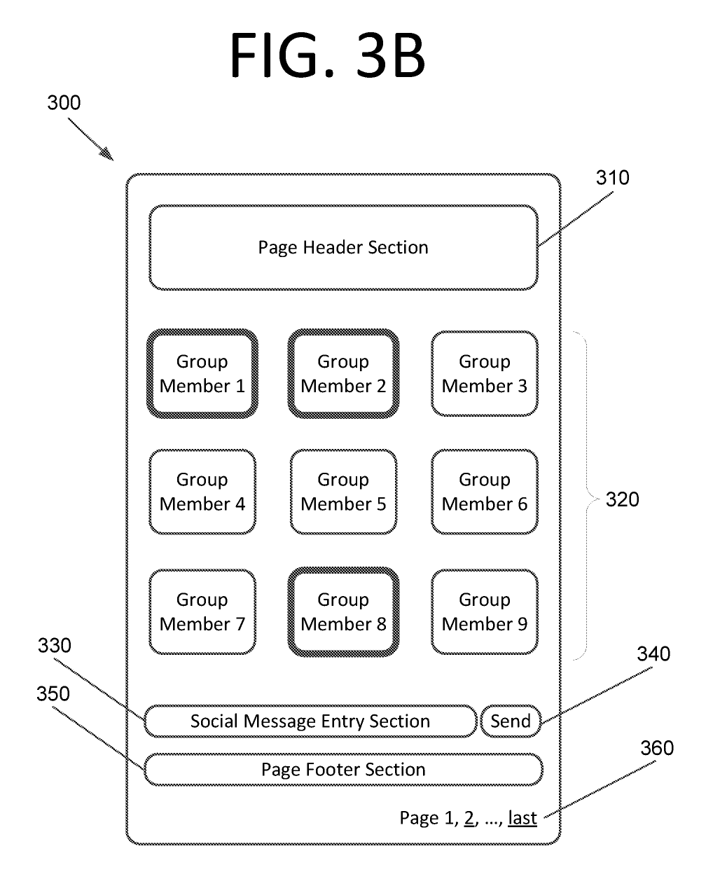

FIG. 3A illustrates a screen 300 of a social networking application showing a plurality of group members, according to an embodiment of the present invention. Screen 300 includes a page header section 310 that can contain relevant information such as sports scores, teams, graphics, or any other appropriate information depending on the purpose and scope of the application. A plurality of group members 320 are shown that belong to a certain group with the user. The group member designations, or icons, for each of group members 320 may be photos, text, graphics, an animation, a combination thereof, or any other suitable designation. The group may be created by the user, or by any other user, software application, or entity. In this embodiment, the shown subset of the group contains nine members, but the number of members shown is a matter of design choice. Further, multiple pages may exist (as is the case here) for groups that exceed the number of members shown on a given page, and a number of pages appropriate to the number of group members per page may be created. For instance, if there are 90 members, Group Members 10-18 could be viewed on the second page, Group Members 19-27 could be viewed on the third page, Group Members 81-90 could be viewed on the last page, etc. Links, buttons, or any other functionality may be included to facilitate pagination such that users can select a page of group members to view.

A social message entry section 330 allows the user to enter a social message, such as a text message, intended for one or more group members, as will be discussed in more detail with respect to FIG. 3B. The user sends the social message, which may be a SMS message or any other suitable format, via send button 340. A page footer section 350 may display any pertinent text or graphics based on the desired application. A pagination scheme 360 allows navigation between the pages of group members. The specific design, layout, presentation, and content shown in screen 300 is a matter of design choice and preference, depending on the subject matter to which the application is directed.

FIG. 3B illustrates the screen 300 of the social networking application after multiple users have been selected, according to an embodiment of the present invention. In this screen, Group Member 1, Group Member 2, and Group Member 8 have been selected, and the borders of the images thereof have been thickened to indicate selection. To select the group members, a user may click the group members with the assistance of a peripheral device such as a mouse, a keyboard, or by touching a haptic (e.g., touch screen) interface such as that of a smart phone. When a group member is selected, the selected group member icon may change color or shape, a sound may be emitted, the computing device may vibrate, a combination of these actions may occur, or any other suitable mechanism may be used to indicate that the user has selected a given group member.

In cases where a pagination scheme is used, the user may move between different pages of a plurality of group members, where at least some of the group members may be different, and select the group members he or she wishes to communicate with on one or more pages. Once the user has selected one or more group members with whom he or she wishes to communicate, the user may enter a social message into social message entry section 330 and then send the social message by using send button 340. In some embodiments, the most recent messages shown may be displayed on screen 300 (not shown here).

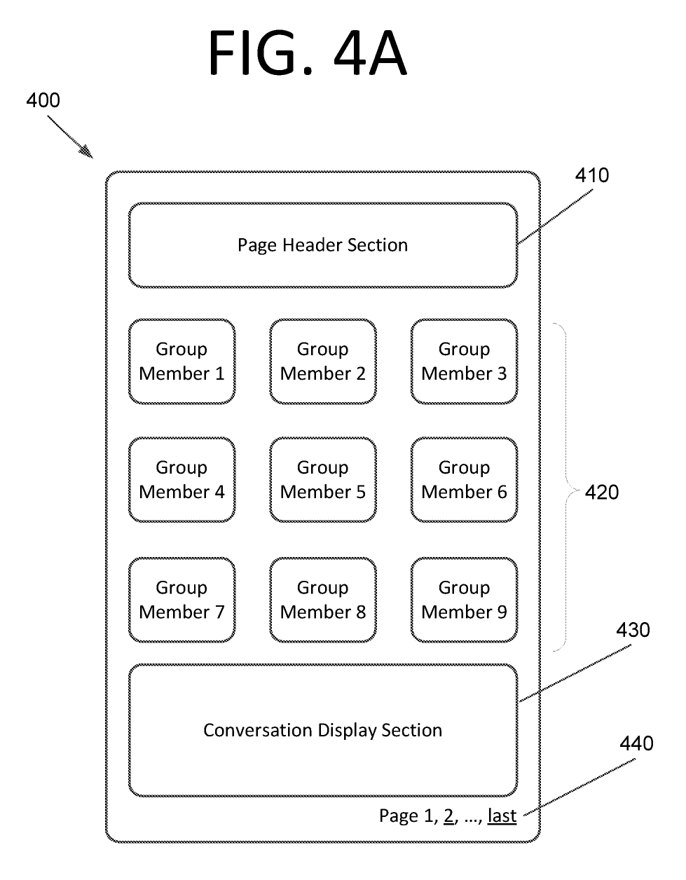

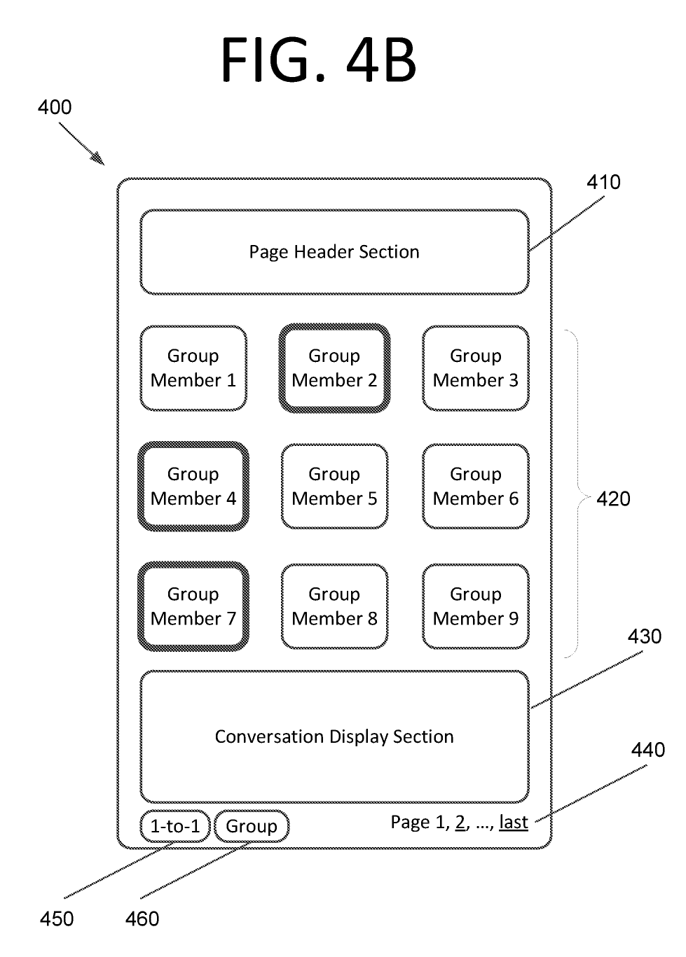

FIG. 4A illustrates a screen of a social networking application 400 showing a plurality of group members, according to an embodiment of the present invention. Screen 400 includes a page header section 410 that can contain relevant information such as sports scores, teams, graphics, or any other appropriate information depending on the purpose of the application. A plurality of group members 420 are shown that belong to a certain group with the user. A conversation display section 430 shows conversations between group members, which can be selected as discussed with respect to FIG. 4B. A pagination scheme 440 allows navigation between the pages of group members. The specific design, layout, presentation, and content shown in screen 400 is a matter of design choice and preference, depending on the subject matter to which the application is directed.

In some embodiments, rather than manually selecting group members, the selection may occur via an automated process, such as software that identifies the group members that the user communicates with most frequently or most recently. Selections may also be automatically made based on geographic location, common interests, or any other criteria or indicia for categorizing groups of individuals. Selections of individuals, whether made manually by the user or by automated tools, may persist for a predetermined time or for the duration of an event, or the selections may persist until modified or cancelled by the user.

FIG. 4B illustrates the screen 400 of the social networking application after a plurality of group members have been selected, according to an embodiment of the present invention. In this screen, Group Member 2, Group Member 4, and Group Member 7 have been selected, and the borders of the images thereof have been thickened to indicate selection. To select the group members, a user may click the group members with the assistance of a peripheral device such as a mouse, a keyboard, or touch a haptic (e.g., touch screen) interface such as that of a smart phone. When a group member is selected, the selected member icon may change color or shape, a sound may be emitted, the computing device may vibrate, a combination of these actions may occur, or any other suitable mechanism may be used.

In cases where a pagination scheme is used, the user may move between different pages of a plurality of group members, at least some of which may be different, and select the group members they wish to communicate with. Once the user has selected one or more group members that he or she wishes to “eavesdrop” on, the user may view conversations in conversation display section 430. In some embodiments, the most recent message may be displayed. In other embodiments, multiple previous messages may be displayed.

The eavesdropping functionality is more similar to how individuals actually communicate conversationally in many real life situations than forum-based methods. For instance, when individuals are at a party, a bar, or another social venue, they often overhear conversations between others and choose to chime in on a given topic. While this may often be considered to be undesirable between strangers online, where a group of individuals in a social networking application share a relationship, or at least a common interest, the ability to view conversations pertaining to certain topics such as sports, for example, between family and/or friends can enhance the user experience for the application.

In some embodiments, the user may need to designate two individuals at a time, or just a conversation between the two, and press a button to follow conversations between those individuals. In other embodiments, conversations between any two or more of the selected individuals may be followed. In yet other embodiments, such as depicted here, separate buttons may exist to follow conversations between two individuals, or to follow conversations among a group of individuals. 1-to-1 conversation selection button 450 allows the user to follow conversations between any two of the selected individuals. Group conversation selection button 460 allows the user to follow group conversations between all or any subset of the selected group members. In other embodiments, subgroups may be user-defined, software-defined, or defined using any other mechanism. A listing of the existing subsets may be provided so the user can select group conversations to follow, and such group conversations may be selected without selecting individual group members in some embodiments. However, any button configuration and/or selection interface may be used in some embodiments.

In this embodiment, buttons 450 and 460 for following conversations may only appear when the user selects at least two group members (note their absence in FIG. 4A). However, in other embodiments, the buttons may be displayed prior to selection, or some mechanism other than buttons may be used for selection, such as radio buttons, a dropdown menu, or any other suitable mechanism or widget.

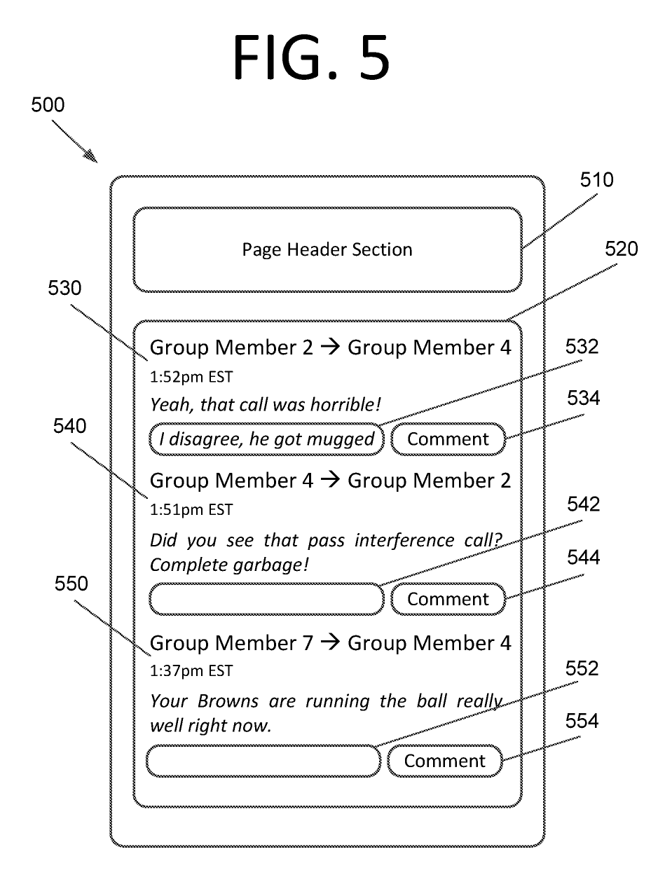

FIG. 5 illustrates a screen 500 of a social networking application where communications between selected group members are shown, according to an embodiment of the present invention. Screen 500 includes a page header section 510 that can contain relevant information such as sports scores, teams, graphics, or any other appropriate information depending on the purpose of the application. A conversation display section 520 shows an ordered listing, from most recent to least recent, of messages 530, 540, and 550 between the group members selected in FIG. 4B. Social message entry sections 532, 542, and 552 enable social messages to be entered for each of conversations 530, 540, and 550, respectively, and the user can send social messages to respective group members participating in a conversation by clicking on associated comment buttons 534, 544, or 554. In this case, the user has entered text into social message entry section 532 to comment on a conversation between Group Member 2 and Group Member 4.

In other embodiments, a screen may exist where listings of pairs and/or groups of group members who are conversing are provided, and a user can view all conversations between two group members and make comments by selecting the appropriate item on the listing. Also, the conversation functionality discussed above may be displayed on any other page of the application, or in any other format. Further, the user may be notified of new conversations between two or more group members via an SMS message, e-mail, sound, vibration, change in text and/or color of the application, or by any other suitable means. Further, for all elements discussed in all screens herein, scrolling functionality or any other browsing functionality may be used for convenient navigation of the pages of the application.

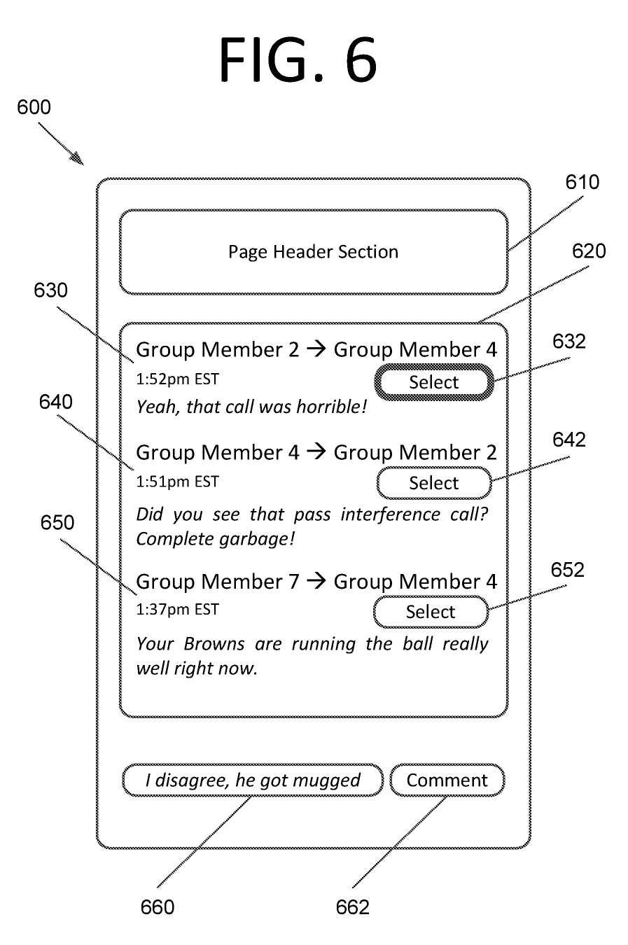

FIG. 6 illustrates a screen 600 of a social networking application where communications between selected group members are shown, according to an embodiment of the present invention. Unlike FIG. 5, in this embodiment, a common text entry section 660 and a single comment button 662 are included and conversations that the user wants to chime in on are individually selected. Screen 600 includes a page header section 610 that can contain relevant information such as sports scores, teams, graphics, or any other appropriate information depending on the purpose of the application. A conversation display section 620 shows an ordered listing, from most recent to least recent, of messages 630, 640, and 650 between the group members selected in FIG. 4B.

Conversation selection buttons 632, 642, and 652 select conversations 630, 640, and 650, respectively, for comment via common social message entry section 660 and comment button 662. In this case, the user has selected conversation 630 via conversation selection button 632, which has changed in appearance to indicate selection. In this case, the user has entered text in social message entry section 660, which would be sent to Group Member 2 and Group Member 4 upon pressing comment button 662.

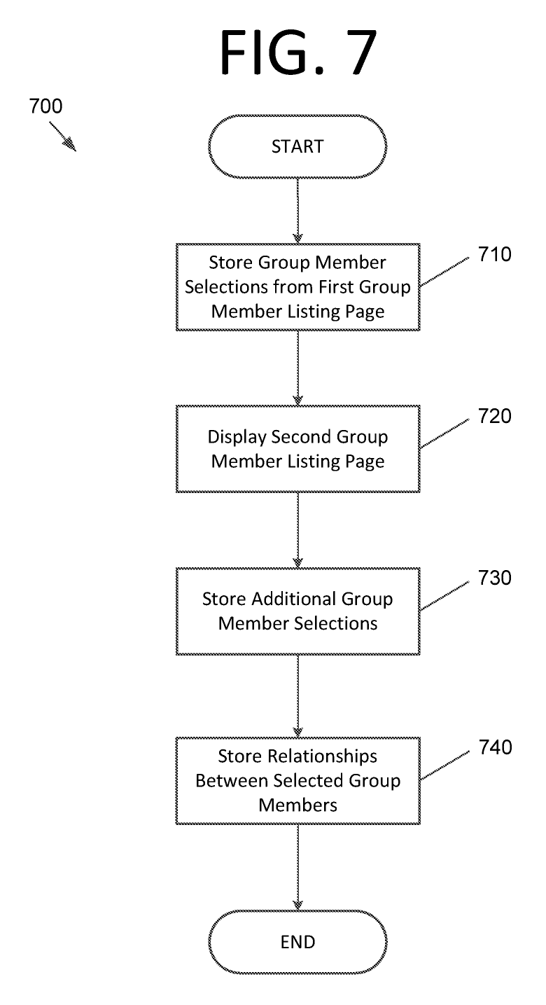

FIG. 7 illustrates a flowchart 700 of a method for receiving and storing selections of group members, according to an embodiment of the present invention. The method may be performed, for example, by the systems shown in FIGS. 1 and 2 in some embodiments. A computing system first stores one or more group member selections from a first group member listing page at 710. These group member selections may be made, for example, via a haptic interface of a smart phone where a user touches icons pertaining to desired group members that he or she wants to monitor conversations for.

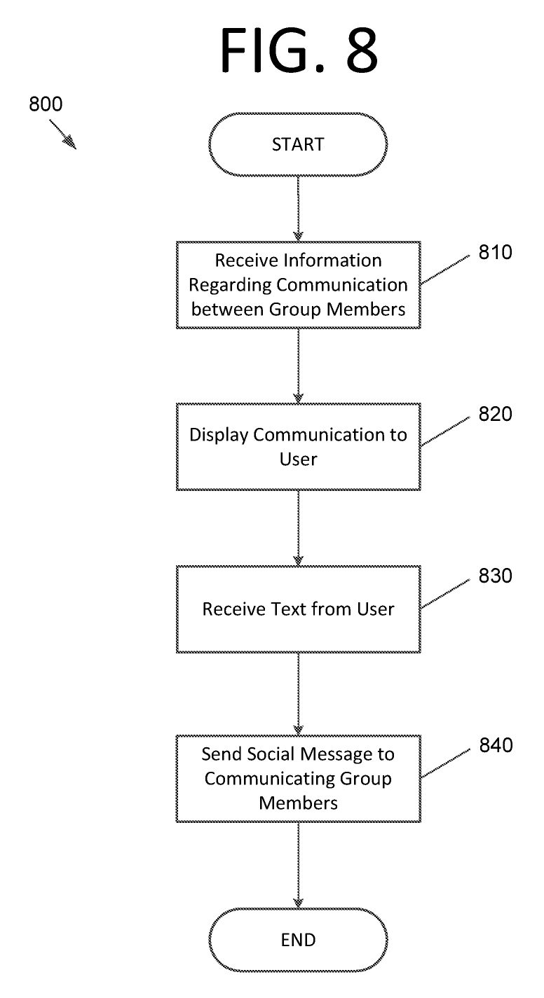

The computing system then displays a second group member listing page at 720. This second page may be displayed in response to a user navigating to a new set of group members via pagination functionality The computing system stores one or more additional group member selections from the second group member listing page at 730. Next, the computing system stores relationships between the selected group members at 740. These relationships may be indications that 1-to-1 conversations between selected group members and/or between sets of group members are to be tracked. The monitoring and reporting of conversations between selected group members to the user is discussed in more detail below with respect to FIG. 8.

FIG. 8 illustrates a flowchart 800 of a method for monitoring, viewing, and joining in on group member conversations, according to an embodiment of the present invention. The method may be performed, for example, by the systems shown in FIGS. 1 and 2 in some embodiments. A computing system receives information pertaining to a communication between group members at 810. For example, the computing system may receive the text of a communication in the conversation between group members, the names of the group members (or an identifier identifying the pairing or group of group members), the time at which the communication took place, etc. The computing system then displays the communication to the user at 820. The communication may be in the context of a conversation between two or more users in some embodiments.

The computing system then receives a social message from a user at 830. Through an interface, the user may select a conversation to join in on, enter the text, and then press a button (or use any other selection mechanism) to indicate that he or she wishes to add the text to the conversation. The computing system then sends the social messsage provided by the user to the other group members involved in the conversation at 840.

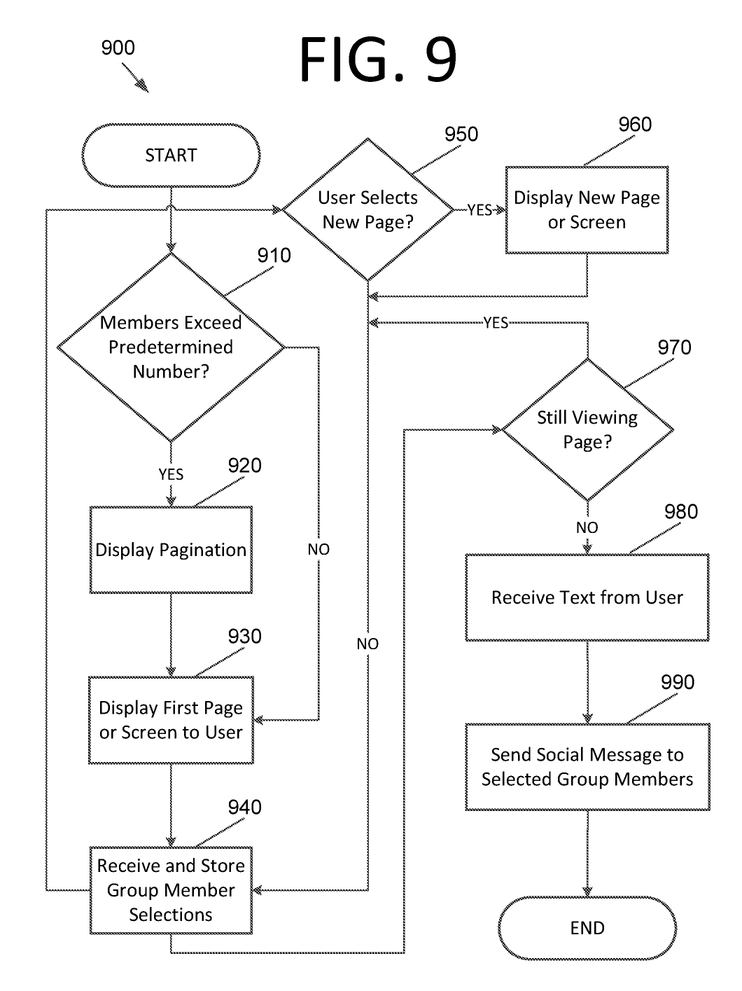

FIG. 9 illustrates a flowchart 900 of a method for facilitating quick and easy selection of group members, according to an embodiment of the present invention. The method may be performed, for example, by the systems shown in FIGS. 1 and 2 in some embodiments. The method includes determining whether a number of group members to be displayed to the user exceeds a predetermined number at 910. If so, pagination is displayed at 920. Thereafter, or if the predetermined number is not exceeded, the process proceeds to displaying a first page or screen with a plurality of designations of members of a group to a user at 930. The group members that are displayed may be chosen in some embodiments via an automated process based on group members the user communicates with most frequently or most recently. In some other embodiments, the automated process may choose group members based on geographic location or common interests relative to the user.

If the user makes group member selections, these selections are received and stored at 940. The group member selections may persist for a predetermined period of time, for the duration of an event, or until modified or cancelled by the user in some embodiments. If the user selects a new page or screen at 950 via available pagination options, the new page or screen is displayed at 960. If the user is still viewing the page or screen at 970, the process proceeds back to receiving and storing group member selections at 940, if such selections are made. If the user is no longer merely viewing the screen at 970 and chooses to enter text to send to the selected group members, the text is received from the user at 980 and then sent as a social message to the plurality of selected group members at 990.

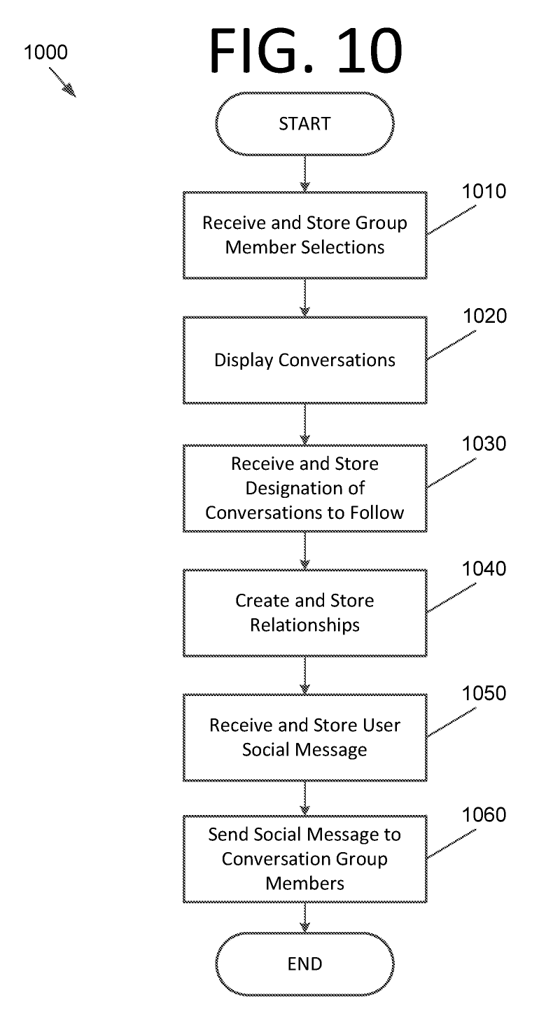

FIG. 10 illustrates a flowchart 1000 of a method for “eavesdropping” on a conversation between a pair or group of group members, according to an embodiment of the present invention. The method may be performed, for example, by the systems shown in FIGS. 1 and 2 in some embodiments. The method includes receiving and storing a plurality of group member selections from a user or automated process at 1010. One or more conversations between two or more of the plurality of selected group members are then displayed to the user at 1020. In some embodiments, a predetermined number of the most recent messages in the conversations may be displayed.

Next, a designation from the user to follow one or more conversations between two or more group members is received and stored at 1030. In some embodiments, only conversations between pairs of the selected group members may be followed. In other embodiments, conversations between all selected group members, and/or between one or more subgroups of the selected group members, are followed. Relationships between the two or more individuals such that conversations may be tracked, provided to, and displayed to the user are then created and stored at 1040. In some cases, the relationships may have been previously created and stored in a database and do not need to be created and stored again. Some embodiments may check for previously existing relationships and reference these relationships when they are discovered.

Text from the user to be contributed to one or more of the displayed conversations is then received and stored at 1050. In some embodiments, the user may designate multiple conversations to submit the same social message to. The social message is then sent to group members of the one or more conversations to which the user wishes to contribute at 1060.

Some embodiments of the present invention pertain to a unique group member selection and communication mechanism provided via a social networking software application running on a computing system. The application may facilitate selection of two or more members of a group whose communications a user of the application wishes to monitor. The user may then receive and view communications between the two or more group members and add to the conversation if the user so desires.

It should be noted that reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

1. A computer program embodied on a non-transitory computer-readable medium, the program configured to cause at least one processor to:
display a first page or screen with a plurality of designations of members of a group to a user;
receive and store a plurality of group member selections made by the user;
receive and store a social message from the user; and
send the social message to the plurality of selected group members.

2. The computer program of claim 1, wherein the program is configured to cause the at least one processor to choose group members for display via an automated process based on the group members the user communicates with most frequently or most recently.

3. The computer program of claim 1, wherein the program is configured to cause the at least one processor to choose group members for display based on geographic location or common interests.

4. The computer program of claim 1, wherein the group member selections persist for a predetermined period of time, for a duration of an event, or until modified or cancelled by the user.

5. The computer program of claim 1, wherein when a number of group members to be displayed to the user exceeds a predetermined number, the program is further configured to cause the at least one processor to:
display a pagination indicator that permits selection of multiple pages of group members by the user;
display a second page or screen responsive to user selection of the pagination indicator; and
receive and store at least one group member selection from the second page or screen.

6. A computer program embodied on a non-transitory computer-readable medium, the program configured to cause at least one processor to:
receive and store a plurality of group member selections from a user or an automated process; and
display one or more conversations between two or more of the plurality of selected group members to the user.

7. The computer program of claim 6, wherein the program is further configured to cause the at least one processor to:
receive and store a social message from the user to be contributed to one or more of the displayed conversations; and
send the social message to group members of the one or more conversations to which the user wishes to contribute.

8. The computer program of claim 6, wherein a predetermined number of the most recent messages in the one or more conversations are displayed.

9. The computer program of claim 6, wherein the program is further configured to cause the at least one processor to:
receive a designation from the user to follow one or more conversations between two or more group members; and
create and store relationships between the two or more individuals such that conversations may be tracked, provided to, and displayed to the user.

10. The computer program of claim 9, wherein the program is configured to cause the at least one processor to only follow conversations between pairs of the selected group members.

11. The computer program of claim 9, wherein the program is configured to cause the at least one processor to follow conversations between all selected group members, and/or between one or more subgroups of the selected group members.

12. A computer-implemented method, comprising:
receiving and storing, by a computing system, a plurality of group member selections from a user or an automated process; and
displaying, by the computing system, one or more conversations between two or more of the plurality of selected group members to the user.

13. The computer-implemented method of claim 12, further comprising:
receiving and storing, by the computing system, a social message from the user to be contributed to one or more of the displayed conversations; and
sending the social message, by the computing system, to group members of the one or more conversations to which the user wishes to contribute.

14. The computer-implemented method of claim 12, wherein a predetermined number of the most recent messages in the one or more conversations are displayed.

15. The computer-implemented method of claim 12, further comprising:
receiving, by the computing system, a designation from the user to follow one or more conversations between two or more group members; and
creating and storing, by the computing system, relationships between the two or more individuals such that conversations may be tracked, provided to, and displayed to the user.

16. The computer-implemented method of claim 15, wherein only conversations between pairs of the selected group members are followed.

17. The computer-implemented method of claim 12, wherein conversations between all selected group members, and/or between one or more subgroups of the selected group members are followed.

18. The computer program of claim 1, wherein the program is further configured to cause the at least one processor to cause the group member designations to persist for a predetermined period of time or for a duration of an event.

19. The computer program of claim 6, wherein the program is further configured to cause the at least one processor to cause the group member designations to persist for a predetermined period of time or for a duration of an event.

20. The computer-implemented method of claim 12, wherein the group member designations persist for a predetermined period of time or for a duration of an event.
